(19) United States
(12) Patent Application Publication
(10) Pub. No.: US 2025/0316918 A1
(43) Pub. Date: Oct. 9, 2025

(54) SYSTEM AND METHOD FOR NON-PLANAR CONNECTORS

(71) Applicant: Advanced Printed Electronic Solutions LLC, Fishkill, NY (US)

(72) Inventor: Richard Neill, Garrison, NY (US)

(21) Appl. No.: 19/170,637

(22) Filed: Apr. 4, 2025

Related U.S. Application Data
(60) Provisional application No. 63/574,496, filed on Apr. 4, 2024.
(60) Provisional application No. 63/730,696, filed on Dec. 11, 2024.

(51) Int. Cl. H01R 12/78; H01R 12/65; H01R 13/621; H01R 13/66; H01R 31/06; H01R 43/18

(52) U.S. Cl. CPC H01R 12/78; H01R 12/65; H01R 13/6608; H01R 13/665; H01R 31/06; H01R 43/18; H01R 13/6215

(57) ABSTRACT

A non-planar connector including a first non-planar connector component coupled to a first electronic assembly, the first non-planar connector component having at least one male circuit interface and a second non-planar connector component coupled to a second electronic assembly, the second non-planar connector component having at least one female circuit interface, each of the at least one female circuit interfaces corresponding to one of the at least one male circuit interfaces. When the first nonplanar connector component and the second non-planar connector components are in a mating arrangement, the at least one male circuit interface align and are coupled to the at least one female circuit interface and the first electronic assembly is integrated electrically with the second electronic assembly. A shape of the first non-planar connector component is configured to couple with a shape of the second non-planar connector component in the mating arrangement.

### RELATED APPLICATIONS

This application claims the benefit of priority to U.S. Provisional Application Ser. No. 63/574,496, titled “System and Method for Non-Planar Connectors,” filed Apr. 4, 2024 and claims the benefit of priority to U.S. Provisional Application Ser. No. 63/730,696, titled “System and Method for Dynamic VAT for Volumetric Additive Manufacturing,” filed Dec. 11, 2024 the contents of each of the above applications is hereby incorporated by reference in their entirety.

### BACKGROUND OF THE DISCLOSURE

The subject matter disclosed herein relates to interconnecting electronic assemblies and sub-assemblies to one another including rigid, flexible and cable assemblies, and in particular connectors utilized within electronic assemblies and sub-assemblies that are non-planar in geometry.

Advanced microsystems and printed circuit board assemblies such as found in industrial and commercial products containing electronic assemblies provide dense I/O interfaces such as surface mount, printed circuit board edge connectors, board-to-board connector, board-to-wired, wire-to-connector, and wire-to-wire assemblies based on various connector technologies implemented in a variety of package structures. Over time, the trend has been towards increased complexity and functionality while achieving a smaller form factor, reduction in power, and reduction in cost. Such connector assemblies contain internal interconnected electronic assemblies as well as external connection ports to interface with other electronic assemblies. Such connectors are typically limited to planar and linear connections, e.g., connecting a graphics processing unit (GPU) or memory module to a motherboard of a computer or high-speed cable connections, to accommodate standard size and shaped connectors. Integration with planar assemblies and sub-assemblies, such as printed circuit board (PCB) assembles using headers, connectors, and cable or flex to connectors, are limited to planar or flat structures and are not usable or designed for connections across one or more non-planar structures.

However, limiting the size and shape of the connectors in turn limits design capabilities to planar or substantially planar assemblies. Consequently, with the advent of additive manufacturing and additive manufactured electronics, both planar and non-planar manufacturing capabilities have been expanded and electronic assemblies and sub-assemblies and complex microsystems are more prevalent.

For example, conventional planar connectors use internal wire and circuit networks that are linear or follow orthogonal paths. However, due to advancement in manufacturing techniques and technologies, such as printed spatial interconnects (PSI) discussed in U.S. application Ser. No. 18/963,306 titles “Methods and System for Additive Manufactured Semiconductor Packaging, Assemblies, and Heterogeneous Integration” filed on Nov. 27, 2024, the contents of which are hereby incorporated by reference in its entirety, many electronic assemblies have non-planar surfaces. The PSI is a structure within an electronic device that provides for both planar and non-planar interconnects. Since the PSI is not limited to planar designs and depending on the electronic device the PSI may provide a curved circuit/conductive networks for the corresponding circuit paths using a non-planar connector geometry. This non-planar geometry and requires a non-planar connector or a mounting member to provide suitable connection points for traditional connectors. However, a mounting member adds a layer of complexity to the manufacturing process and also disrupts the surface of the electronic device.

Accordingly while existing systems and methods for interconnecting electronic assemblies are suitable for their intended purposes the need for improvement remains, particularly in providing a system and method for connecting electronic assemblies and subassemblies having non-planar geometry having the features described herein.

### BRIEF DESCRIPTION OF THE DISCLOSURE

According to one aspect of the disclosure, a non-planar connector is provided. The non-planar connector including a first non-planar connector component coupled to a first electronic assembly, the first non-planar connector component having at least one male circuit interface and a second non-planar connector component coupled to a second electronic assembly, the second non-planar connector component having at least one female circuit interface, each of the at least one female circuit interfaces corresponding to one of the at least one male circuit interfaces. When the first nonplanar connector component and the second non-planar connector components are in a mating arrangement, the at least one male circuit interface align and are coupled to the at least one female circuit interface and the first electronic assembly is integrated electrically with the second electronic assembly. A shape of the first non-planar connector component is configured to couple with a shape of the second non-planar connector component in the mating arrangement.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1A is a schematic illustration of a non-planar connector with pin type connectors;

FIG. 1B is a schematic illustration of a connector array;

FIG. 1C is a schematic illustration of a pin and socket type connector;

FIG. 1D is a schematic illustration of a compression type connector;

FIG. 2. is a schematic illustration of a non-planar connector with a socket type connector;

FIG. 3A is a schematic illustration of the non-planar connector along line 3-3 with external pad conductors;

FIG. 3B is a schematic illustration of the non-planar connector along line 3-3 with external compression connectors;

FIG. 4. is a schematic illustration of a nonplanar connector used to couple a cable and a electronic assembly;

FIGS. 5A-5C are schematic illustrations of various types of non-planar connectors; and

FIGS. 6A-6B are schematic illustrations of a non-planar connector coupling two electronic assemblies.

### DETAILED DESCRIPTION OF THE DISCLOSURE

A system and method are described for interconnecting non-planar electronic assemblies and sub-assemblies to one another including rigid, flexible, and cable assemblies, combinations thereof. While current methods for integrating assemblies and sub-assemblies, such as printed circuit board (PCB) assembles using headers, connectors, and cable or flex to connectors are suited for planar applications, such methods are not usable or designed for connections across one or more non-planar structures.

The system and method for non-planar connectors described herein provides for rigid, flexible or cable interconnects, although not limited thereto. Whereby a male and a corresponding female connector can join or mate two dissimilar electronic assemblies. The non-planar connectors can mate to one another in multiple formats, geometries, sizes, configurations, material-types, and combinations, for non-planar electronic assemblies and sub-assemblies, such as those that can be created through additive manufacturing methods.

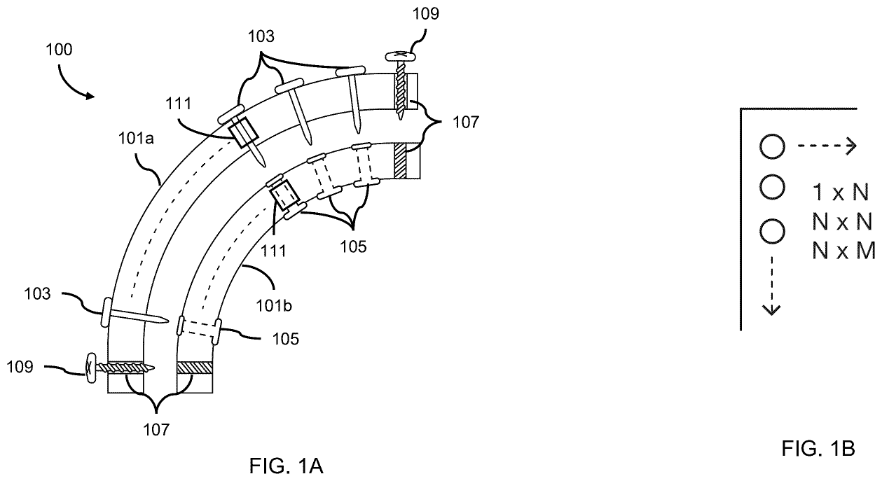

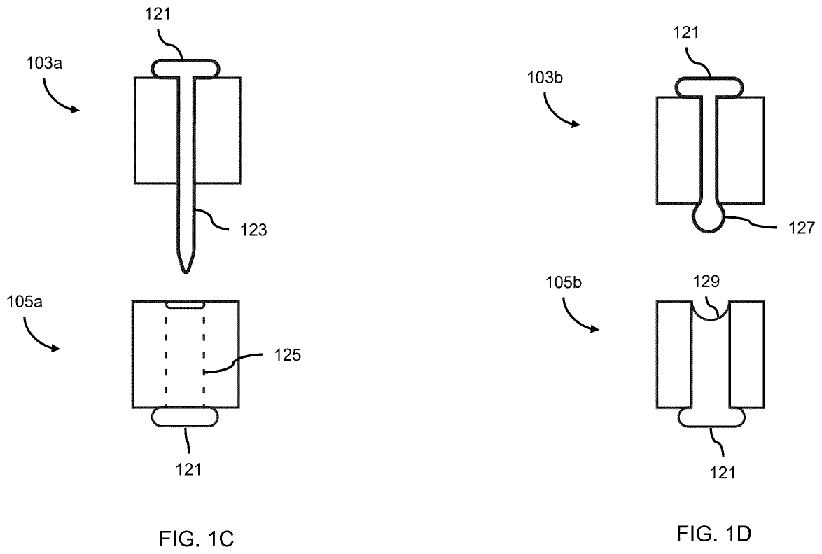

Referring now to FIGS. 1A and 1B, shown is a non-planar connector 100 according to some embodiments of the present disclosure. The non-planar connector 100 may be in any non-planar shape, for example in the shape of a uniform or non-uniform curve, with a male connection side 101a and a female connection side 101b. The shape is representative and non-limiting wherein in an embodiment, the non-planar connector can take on numerous nonplanar shapes, nonplanar geometries, and sizes based on the application requirements. The male connection side 101a having at least one male connector 103 and the female connection side 101b having at least one corresponding female connector 105. While FIG. 1A illustrates the male connection side 101a as being superior to the female connection side 101b, it should be appreciated the male connection side 101a and the female connection side 101b may be in any orientation or configuration with corresponding male and female connectors 103, 105. In some embodiments, male connection side 101a may include a mix of male connectors 103 and female connectors 105 with the female connection side 101b having a mix of corresponding male connectors 103 and female connectors 105.

The male connectors 103 may be a pin or plug connector that can align/mate and connect into a corresponding receptacle or socket, the female connectors 105. In some embodiments, the number of pins/plugs (male connector 103) and jacks/receptacles or socket interfaces (female connector 105) are configurable and can take on several formats, including an array of pins/plugs and correspondence jacks/receptacles/socket interface arrays, e.g. 1×N, N×1, N×N, or N×M (shown in FIG. 1B), where N or M is the number of corresponding pins or plugs making up the non-planar connector 100. In an embodiment, the non-planar connector 100 may be made of any suitable resin, polymer, ceramic, glass, metal, organic or inorganic, or other materials as desired to achieve suitable material properties for a given application. In some embodiments, the non-planar connector 100 may be made of a single material, a mix of materials, or a graded material. In some embodiments, the non-planar connector may be primarily made of a first material, for example a low cost plastic, and have a second materials, for example an insulator, surrounding each male and female connector 103, 105. In some embodiments, the male connection side 101a and the female connection side 101b may be made of the same or different material or combinations of material. In some embodiments this difference in material may be utilized to improve upon or control the electrical, magnetic, and radiating properties and operation of the non-planar connector within an electronic system. For example, by controlling a second material dielectric properties, the RF performance of high-speed signals transiting the non-planar connector can be controlled or manipulated to improve the overall device performance and characteristics.

In some embodiment, the non-planar connector 100 may contain one or more mounting holes 107 through the male connection side 101a and the female connection side 101b to secure/couple the male connection side 101a to the female connection side 101b and/or to an adjacent assembly or underlying VDL. A mounting screw 109 or other type of fastener is inserted through the mounting hole 107 to secure/coupled the male connection side 101a to the female connection side 101b of the non-planar connector 100. In some embodiments, the mounting holes 107 have a threaded bore to accommodate a threaded mounting screw 109. In some embodiments, the female male connection side 101b is integral with the underlying electronic assembly or VDL and the male connection side 101a is coupled to the female connection side 101b. In some embodiments, the mounting screw 109 passes through the mounting hole 107 in the male connection side 101a and the female connection side 101b and the mounting screw 109 mates with the underlying electronic assembly or VDL to secure/couple the male connection side 101a to the female connection side 101b are secured to the underlying electronic assembly or VDL Although the male connection side 101a is described as distal to the underlying electronic assembly and the female connection side 101b is describes as proximal to the underlying electronic assembly, it should be appreciated that the position and configuration of the male connection side 101a and the female connection side 101b may be reversed.

In an embodiment, the non-planar connector 100 may be fabricated utilizing additive manufacturing methods for efficient process chain fabrication, wherein each non-planar connector 100 may be additive manufactured concurrent with other additive manufactured elements such as interconnection circuits, connection interfaces (pin, pad, bump, or socket), semiconductor device placement and integration, sensors, antennas, passive, and active components placement and integration, and other microelectronic components that are part of the fabrication and manufacturing process.

In some embodiments, the non-planar connector 100 may be manufactured using volumetric additive manufacturing (VAM) and overprinting techniques. VAM based printers utilize a VAT or other containers to hold liquid resin, liquid substrates, and other liquid state materials that are selectively polymerized (turned from the liquid state to a solid) to form complex 3-dimensional structures. This is process also referred to as “VAT photopolymerization,” a category of additive manufacturing processes that create 3D objects by selectively curing resin through targeted light-activated polymerization methods. In this way, non-planar connectors can be suspending within a VAT of liquid resin and have the surrounding VDL or electronic assembly be formed around the non-planar connector or a portion thereof, for example the male connection side 101a or the female connection side 101b. Printing “over” preexisting structures, for example non-planar connectors, is referred to as overprinting.

In some embodiments, during the VAM fabrication process, it may be desirable to suspend the VAM fabrication and functionalize the in-process substrate for the deposition of a printed conductive circuit, place electronic components, post-process (curing or cleaning) some portion of the substrate, or otherwise perform some manufacturing operation on the substrate. This may be particularly true when fabricating electronics, as conductive and insulating components are integrated. In one embodiment, the electronic components may include resistors, capacitors, inductors, and other passive or active electronic devices to provide signal conditioning such as noise reduction or impedance matching or control, to the internal connector circuit network in order to improve the performance, signal quality, or connector operation.

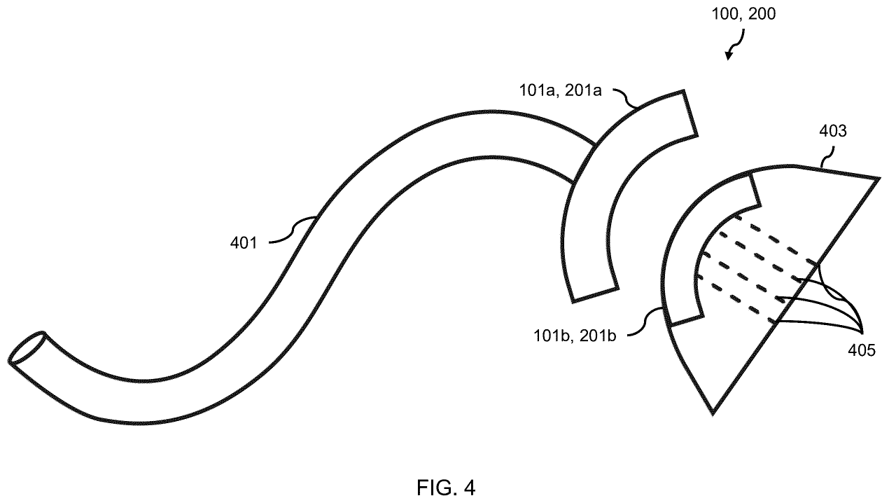

For example, one or more iterative manufacturing processes may be interleaved with the VAM process to print and/or overprint complex multi-functional non-planar structures. In this way, the electronic assembly being manufactured would be laid out and/or suspended in a resin VAT with the non-planar connector shape and printed electronics being prefabricated. The non-planar connector and printed electronics would then be encapsulate by the cured resin through photopolymerization such that the whole structure is printed via the VAM fabrication process. In some embodiments, as required, leaving microfluidic structures/channels (air passages essentially) for cooling or thermal convention of the conductors and or for retrofitting electronic interconnects (shown in FIG. 4).

In one embodiment, the VAM based overprinting process can be utilized to encapsulate a pre-fabricated electronic circuit or internal interconnection network such as a VDL to form a hermitically sealed and fully enclosed non-planar connector device. In this scenario, the metal electronic structure is completed first, then immersed within the resin VAT material where the photopolymerization process forms a rigid body around the metal structure to complete the connector device formation. In this way a body, e.g., the male connection side 101a and the female connections side 101b, of the non-planar connector can be overprinted on a prefabricated electronic interconnection network. In some embodiments, the prefabricated electronic interconnection network can be suspending in a VAM resin VAT, a first material, for example an insulating material, is overprinted on the electronic interconnection network. The electronic interconnection network with the first material is removed and placed into another resin VAT whereby a second materials, for example a rigid plastic, is overprinted the first material. This process may be repeated as desired to form a giving non-planar interconnect with given material properties. For example, in some embodiments, a thermal or radiation shielding or RF tuning layer may be overprinted on the non-planar connector. In some embodiments a single VAT material whose properties can be selectively controlled via wavelength or photonic energy manipulation to structure the materials differently in different location of the non-planar connector may be desirable to control the non-planar connector electrical and magnetic interconnection network behavior.

In some embodiments, a traditional layer-by-layer manufacturing process may be used, whereby the non-planar connector is additively manufactured one layer at a time. The non-planar connector may be fabricated using multiple additive manufacturing processes as desired to add components of the electronic interconnection network at a given layer. In some embodiments, the material of each layer or a portion of each layer of the non-planar connector may be changed to provide given material properties as desired, such as manipulation of dielectric constant or thermal properties within the desired corresponding material layers of interest.

Referring now to FIGS. 1C and 1D, shown are various types of male connector 103 and female connector 105 pairs for use in the non-planar connector 100 according to some emblements of the present disclosure. In some embodiments, illustrated in FIG. 1C, the male connector 103a is a pin type connector and the female connector 105a is a socket type receptacle. The male connector 103a has a surface mount technology (SMT) pad 121 or solder type interface on an exterior side of the non-planar connector 100 to enable connection an electronic assembly and a plug/pin 123 extending opposite the pad 121. In some embodiments, wires or other electrical connections may be soldered (such as solder reflow techniques used in printed circuit board processes) directly to the SMT pad 121. In some embodiments, male connector 103 and female connector 105 pairs may not include a SMT pad 121 and a wire or other electrical connection is in direct electrical communication with the plug/pin 123. The pin 123 is configured to be inserted through a channel/socket 125 of the female connector 105a to interface with a corresponding pad 121 on the opposite side of the non-planar connector 100. In some embodiments, the pin 123 is inserted through the channel 125 and interfaces directly with interconnects of the underlying electronic assembly or VDL.

In some embodiments, illustrated in FIG. 1D, the male connector 103b is a compression type contact and the female connector 105b is a compression type receptacle. The male connector 103b has a SMT pad 121 or ball interface on an exterior side of the non-planar connector 100 to enable connection an electronic assembly and a conductive bump 127 or ball extending opposite the pad 121. The conductive bump 127 is configured to interface with a receptacle 129 or divot of the female connector 105b. In some embodiments, when the male connection side 101a is coupled to the female connection side 101b, a compression force, for example from the mounting screw 109 being secured to the underlying electronic assembly or VDL, will press the conductive bump 127 into the receptacle 129 to form an electrical connection therebetween. In some embodiments, the conductive bump 127 and the receptacle 129 may be elastic having a spring force that biases the conductive bump 127 and the receptacle 129 against the compressive force coupling the male connection side 101a to the female connection side 101b. In this way the conductive bump 127 and the receptacle 129 may form a tighter connection that is less likely to be disconnected. In some embodiments, a spring or other mechanical device may be coupled to the conductive bump 127 and the receptacle 129 to provide the aforementioned spring force. In some embodiments, the conductive bump 127 and the receptacle 129 may be made of a compressive or elastic material or may be coupled to a compressive or elastic material to provide the aforementioned spring force. In some embodiments, the interconnection formed between the SMT pad 121 on either side of the non-planar connector 100 may be part of an embedded component within either an assembly or some additively manufactured electronic assembly. In some embodiments, the interconnects of the additively manufactured electronic assembly are formed concurrently with the electronic assembly using VAM.

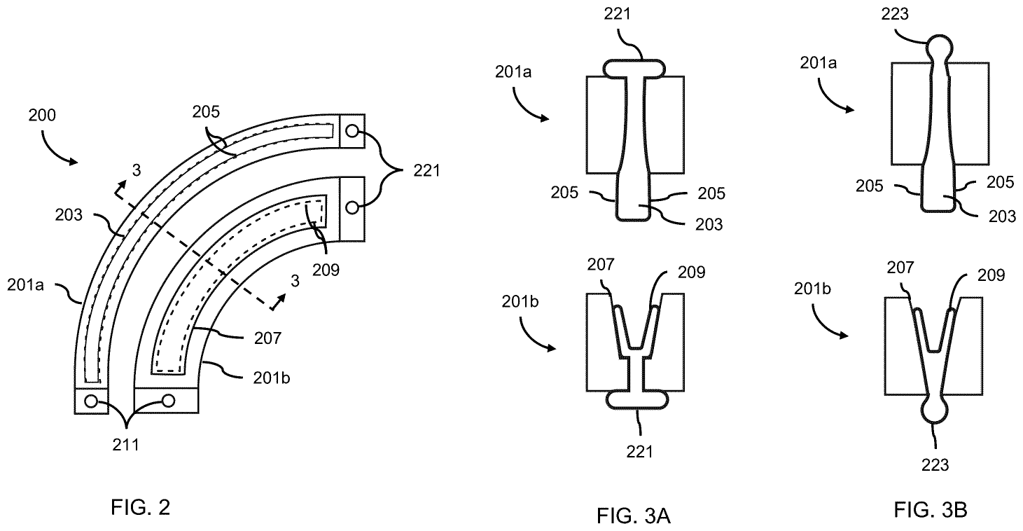

Referring now to FIG. 2, shown is a non-planar connector 200 according to some embodiments of the present disclosure. The non-planar connector 200 may be similar to the non-planar connector 100 and may be in any non-planar shape and have a male connection side 201a and a female connection side 201b. The male connection side 201a may have a male tab 203, with a plurality of contact pads 205, that is configured to slot into a female trench 207 of the female connection side 201b. The female trench 207 having a corresponding number of contact slots 209 configured to couple with the contact pads 205 when the male connection side 201a engages the female connection side 201b. In some embodiments the non-planar connector 200 has a mounting hole 211 therethrough for securing/coupling the non-planar connector 200 to an electronic assembly or VDL via a screw, pin, or other fastener (not shown).

Referring now FIGS. 3A and 3B, shown are cross sectional views of the male connections side 201a and the female connection side 201b along line 3-3 according to some embodiments of the present disclosure. Similar to the embodiments illustrated in FIGS. 1C and 1D, the non-planar connector 200 may include a SMT style conductive pad interface or solder ball interface to enable interconnection and attachments to other microelectronic assembly or sub-assembly circuit networks. In some embodiments, illustrated in FIG. 3A, the male connections side 201a has a SMT pad 221 on an exterior side of the non-planar connector 200 to enable connection an electronic assembly and the male tab 203 with contact pads 205 extends opposite the pad 221. The male tab 203 is configured to be inserted into a trench 205 in the female connection side 201b such that the contact pads 205 engage the contact slots 209 within the trench 207. In some embodiments, illustrated in FIG. 3B, conductive bumps 223, similar to the conductive bumps 127, may be used in place of the SMT pads 221. In this way the non-planar connector 200 may be coupled with external electronic assemblies and subassemblies using a compression force type connection.

Referring now to FIG. 4, shown is a non-planar connector 100, 200 according to some embodiments of the present disclosure. In some embodiments, a cable or flexible circuit 401 is connected to the male connections side 101a, 201a of the non-planar connector 100, 200. The cable or flexible circuit 401 may be made of flexible materials, semi-rigid materials, and fabrics, with variants as described. In some embodiments, an electronic assembly or VDL 403 is connected to the female connection side 101b, 201b of the non-planar connector 100, 200. In some embodiments, the electronic assembly or VDL 403 may include embedded interconnects 405. When the male connections side 101a, 201a is coupled to the female connection side 101b, 201b, signals are transmitted from the cable or flexible circuit 401 to the electronic assembly or VDL 403 and the embedded interconnects 405.

In some embodiments, the non-planar connector 100, 200 may include provisions for electromagnetic interference (EMI), radio frequency (RF), signal conditioning, or radiation shielding, as well as provisions for thermal energy transfer and dissipation. For example, a material of the male connections side 101a, 201a is coupled to the female connection side 101b, 201b, may have a shielding property or an additional shielding layer may be disposed partially or fully around the male connections side 101a, 201a is coupled to the female connection side 101b, 201b.

In some embodiments, the non-planar connector 100, 200 may include passive and active electronic devices 111 to modified one or more properties of the non-planar connector 100, 200. Passive devices may include resistors, capacitors, coils, inductors, and combinations thereof. Active devices may include transistors, analog or digital conditioning circuits, voltage regulators, and other integrated circuit devices. The passive and active devices 111 may be inserted or deposed within the non-planar connector such that the passive and active devices are in series or parallel to the interconnection networks and PSI, or may form a more complex interconnection scheme when utilizing multi-terminal devices such as integrated circuits. The effect of integrating passive and active devices is to change the electrical, magnetic including RF behavior of the non-planar connector as it relates to the input-output characteristics of the non-planar connector interfaces. For example, in the case of series resistor elements, such resistive devices can be utilized to change the non-planar connector contact interface impedance values or to reduce transmission of noise due to signal propagation properties. The introduction of capacitor devices in series or parallel of the interconnection network or PSI can be used to implement a variety of filtering functionality within the non-planar connector for noise reduction. Similarly, integrating a active device, such as a voltage regulator has the effect of maintaining voltage levels across the non-planar connector due to variations of power or current demands. In other embodiments, active devices may comprise electrical-to-photonic conversion devices that are embedded and integrated within the non-planar connector to adapt one side of the non-planar connector interface which may be a fiber optical interface to the opposing connector interface which may be an electrical-based interface type as described herein.

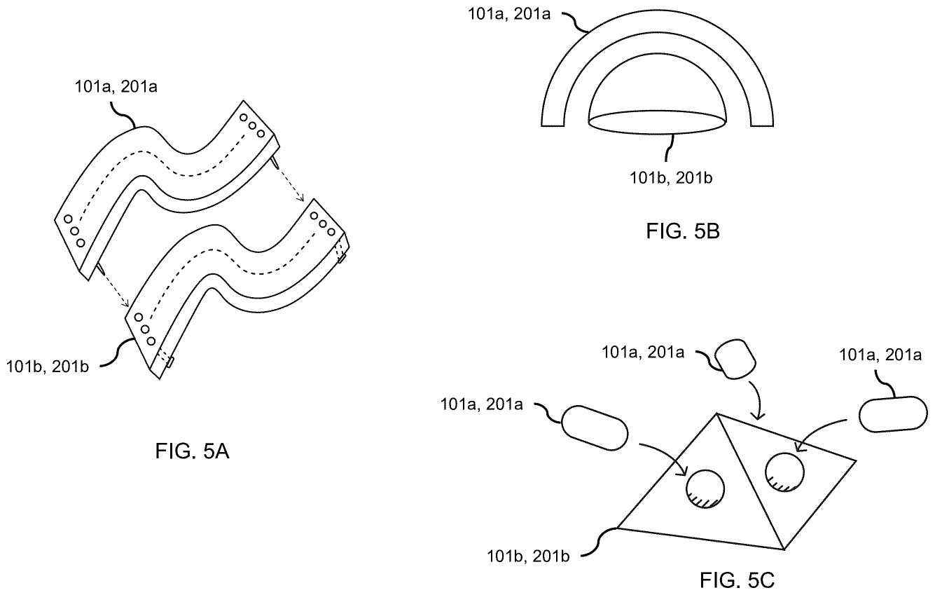

Referring to FIGS. 5A-5C, shown are various non-planar connectors implemented with a plurality of shapes, geometries, size and pad or interface configurations according to some embodiments of the present disclosure. It should be appreciated that the examples presented are non-limiting, and in an embodiment many different connectors and their corresponding format, arrangements, shapes, geometries, sizes, pin, plug, socket, receptacle configurations, materials, integration to cables, rigid, flexible and/or stretchable implementations, and mounting mechanisms can be implemented using the system and methods described herein and without deviating from the teachings herein. FIG. 5A illustrates a flexible non-planar sheet connector embodiment, whereby the non-planar connector may be a preset or variable non-planar shape. FIG. 5B illustrates a dome and shell non-planar connector embodiment, whereby the male connection side 101a, 201a may partially or fully cover and couple to the female connection side 101b, 201b. FIG. 5C illustrates a multi-module non-planar connector, whereby one or more electronic subassemblies or modules associated with the male connection side 101a, 201a are configured to couple with the female connection side 101b, 201b of another electronic subassembly or module.

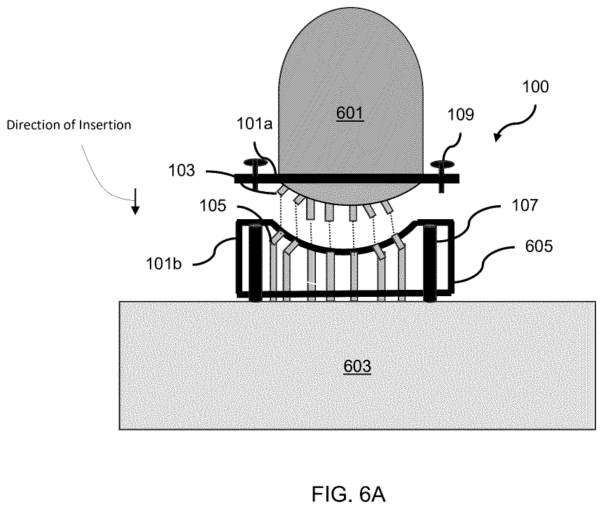

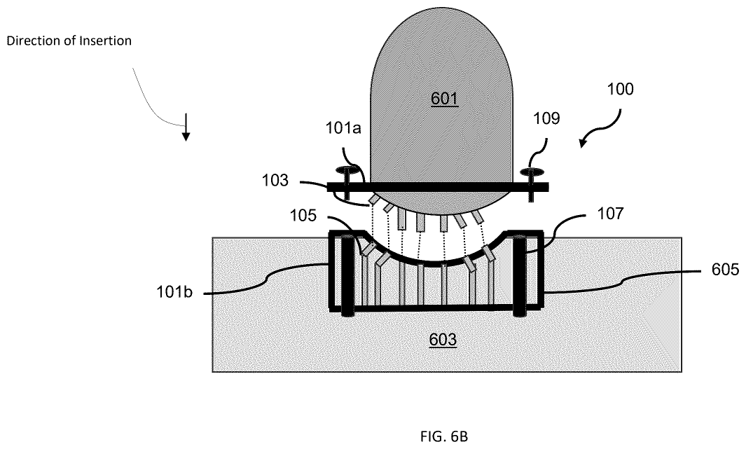

Referring now to FIGS. 6A and 6B, shown are electronic assemblies coupled to one another using a non-planar connector 100 according to some embodiments of the present disclosure. In some embodiments, a first electronic assembly 601 is coupled to a second electronic assembly 603 via a non-planar connector, e.g., non-planar connector 100. The male connection side 101a may be coupled to or integral with the first electronic assembly 601 and the female connection side 101b may be coupled to and integral with the second electronics assembly 603 such that when the male connection side 101a and the female connection side 101b of the non-planar connector 100 are coupled together, the first electronics assembly 601 and the second electronic assembly 603 are in electrical communication with each other.

In some embodiments, the female connection side 101b may be mounted on a frame 605 which is coupled to the second electronic assembly 603 (shown in FIG. 6A). In this way a planar electronic assembly can be adapted for use with a non-planar connector. In some embodiments, the frame 605 is formed as part of the second electronic assembly 603 (shown in FIG. 6B). In some embodiments, the electronic assemblies 601, 603 may be manufactured using additive manufacturing techniques, for example VAM and overprinting, such that the frame 605 is formed at the same time as the non-planar connector 100, the female connection side 101b, and/or one or more electronic assemblies 601, 603.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects or may include aspects describe in relation to other embodiments in combination. Accordingly, the disclosure is not to be seen as limited by the foregoing description, but is only limited by the scope of the appended claims.

What is claimed is:

1. A non-planar connector comprising:
a first non-planar connector component coupled to a first electronic assembly, the first non-planar connector component having at least one male circuit interface;
a second non-planar connector component coupled to a second electronic assembly, the second non-planar connector component having at least one female circuit interface, each of the at least one female circuit interfaces corresponding to one of the at least one male circuit interfaces;
wherein when the first nonplanar connector component and the second non-planar connector components are in a mating arrangement, the at least one male circuit interface align and are coupled to the at least one female circuit interface and the first electronic assembly is integrated electrically with the second electronic assembly;
wherein a shape of the first non-planar connector component is configured to couple with a shape of the second non-planar connector component in the mating arrangement.

2. The non-planar connector of claim 1, wherein the at least one male circuit interface is one of:
a pin;
a solder type interface; or
a component interconnect.

3. The non-planar connector of claim 1, wherein the at least one female circuit interface is one of:
a channel;
a conductive receptacle; or
a component interconnect.

4. The non-planar connector of claim 1, wherein the first non-planar connector component and the second non-planar connector component are flexible and have a variable shape.

5. The non-planar connector of claim 1, wherein the first non-planar connector component and the second non-planar connector component are manufactured using one or more of:
subtractive manufacturing;
plastic fabrication;
additive manufacturing methods;
volumetric additive manufacturing (VAM); or
a combination thereof.

6. The non-planar connector of claim 1, further comprising a plurality of conductive pads, each conductive pad associated with one of the at least one male interfaces and the at least one female interfaces, the conductive pads enabling direct electrical connection to a conductive circuit.

7. The non-planar connector of clam 1, further comprising a frame for mounting one of the first non-planar connector component or the second non-planar connector component to a planar electronic assembly.

8. The non-planar connector of claim 7, wherein the frame is integral with the planar electronic assembly.

9. The non-planar connector of claim 8, wherein the frame is manufactured integrally with the planar electronic assembly.

10. The non-planar connector of claim 7, wherein the first non-planar connector component is coupled to the second non-planar connector component using a fastener in the mating arrangement.

11. The non-planar connector of claim 10, wherein the one of the first non-planar connector component or the second non-planar connector component is mounted on the frame using the fastener.

12. The non-planar connector of claim 11, wherein the fastener is coupled to the planar electronic assembly using the fastener.

13. The non-planar connector of claim 5, wherein the non-planar connector is manufactured using VAM to overprint the first non-planar connector component on the at least one male circuit interface and overprint the second non-planar connector component on the at least one female circuit interface.

14. The non-planar connector of claim 13, wherein the at least one male circuit interface and the at least female circuit interface are pre-existing structures prior to manufacturing the non-planar connector.

15. The non-planar connector of claim 1, further comprising a shield around the first non-planar connector component or the second non-planar connector component.

16. The non-planar connector of claim 15, wherein the shield is one or more of:
an electromagnetic interference shield;
a radio frequency shield;
a radiation shield; and
a thermal shield.

17. The non-planar connector of claim 1, further comprising a passive device or an active device coupled to the at least one male circuit interface and the at least one female circuit interface.

18. The non-planar connector of claim 17, wherein the passive device is one or more of:
a resistor;
a capacitor;
a coil; and
an inductor.

19. The non-planar connector of claim 17, wherein the active device is one or more of:
a transistor;
an analog or digital conditioning circuit;
a voltage regulator; and
an integrated circuit device.

20. The non-planar connector of claim 1, a first material having a first material property is disposed around the at least one male circuit interface and the at least one female circuit interface and a second material having a second material property is disposed around the first material, the first material property is different from the second material property.
